(19) United States
(12) Patent Application Publication
(10) Pub. No.: US 2009/0159831 A1
(43) Pub. Date: Jun. 25, 2009

(54) LOCATING STRUCTURE OF A WATER CONTROL VALVE

(76) Inventor: Hao Nan PENG, Tanzih Township (TW)

Correspondence Address: EGBERT LAW OFFICES, 412 MAIN STREET, 7TH FLOOR, HOUSTON, TX, 77002, US

(21) Appl. No.: 11/961,565

(22) Filed: Dec. 20, 2007

(51) Int. Cl. F16K 27/00

(52) U.S. Cl. 251/367; 137/377

(57) ABSTRACT

The present invention provides an improved locating structure of a water control valve casing. There are first and second coupling portions opposite to each other on the casing and base, as well as a locator for combining the first and second coupling portions. The first and second coupling portions are either punch holes or guide channels opposite to the snapping channel, which are separately screwed or snapped by a pin column or C-shaped locator. The locator permits positioning by screwing with the pin column, or by snapping with a C-shaped fastener. The casing and base of the water control valve are engaged more securely, thus protecting the internal components with improved applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a water control valve, and more particularly to an innovative water control valve having a casing with a locating structure.

2. Description of Related Art Including Information Disclosed Under 37 CFR 1.97 and 37 CFR 1.98

The water control valve (also referred to as a valve core) is an integral part of hydrants. As far as a ceramic water control valve is concerned, a brake seat driven by a brake rod, a ceramic locating disc and spinning disc are arranged internally, while a valve casing is assembled externally. A base for supporting the locating disc and spinning disc are also provided. Thus, this integrated casing enables positioning of internal components.

The casing of a typical water control valve is snapped with the locating structure on the base. Generally, a slot is opened on the casing of the water control valve, and a snapping column is protruded correspondingly to the base. When the casing and base are assembled together, said snapping column is inserted into the slot for positioning purpose.

The following shortcomings are observed during the actual applications.

As a component of a hydrant structure manufactured at other sites, the factory-made water control valve is assembled onto the hydrant after a series of quality inspections, packaging, handling and storage. So, the water control valve will face the risk of vibration, collision or even being dropped. As the casing of the water control valve is snapped onto the base with only a depth of about 0.5 mm, it is possibly disengaged from the base, leading to damage of the ceramic locating disc and spinning disc and unnecessary loss of cost. Moreover, the casing and base are generally made of plastic materials. The snapping column is prone to rupture due to vibration, collision or drops, resulting in a failure to re-assemble and relocation of the casing and base.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the locating structure comprising first and second coupling portions opposite to each other on the casing and base, as well as a locator, permitting positioning by screwing with pin column as shown in FIGS. 1-6 or by snapping with a C-shaped fastener as shown in FIGS. 7, 8, and 9, the casing and base of the water control valve could be engaged more securely, thus protecting the internal components with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the preferred embodiment of the present invention.

FIG. 2 shows an exploded perspective view of the preferred embodiment of the present invention.

FIG. 3 shows a partially assembled sectional view of the preferred embodiment of the present invention.

FIG. 4 shows an exploded perspective view of another preferred embodiment of the present invention.

FIG. 5 shows an exploded elevation view of another preferred embodiment of the present invention.

FIG. 6 shows an enlarged and partial assembled elevation view of another preferred embodiment of the present invention.

FIG. 7 shows an exploded perspective view of another preferred embodiment of the present invention.

FIG. 8 shows an assembled elevation view of another preferred embodiment of the present invention.

FIG. 9 shows a partially assembled sectional view of another preferred embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

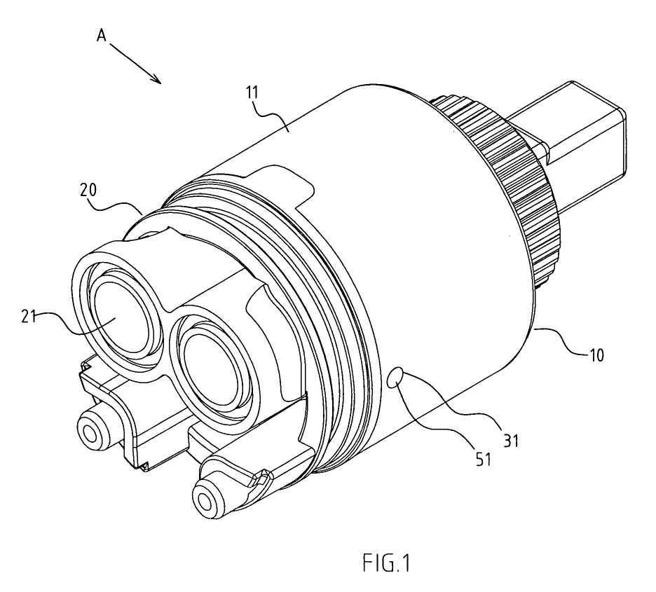

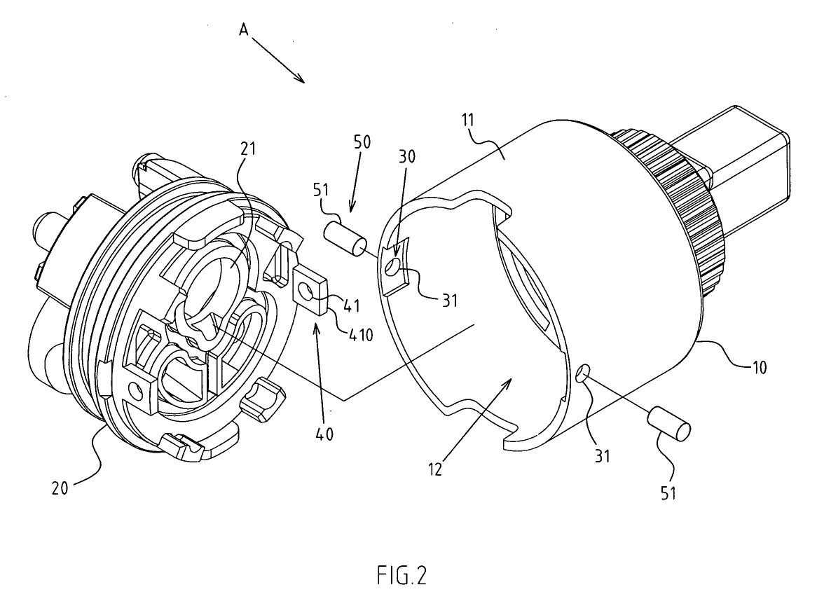

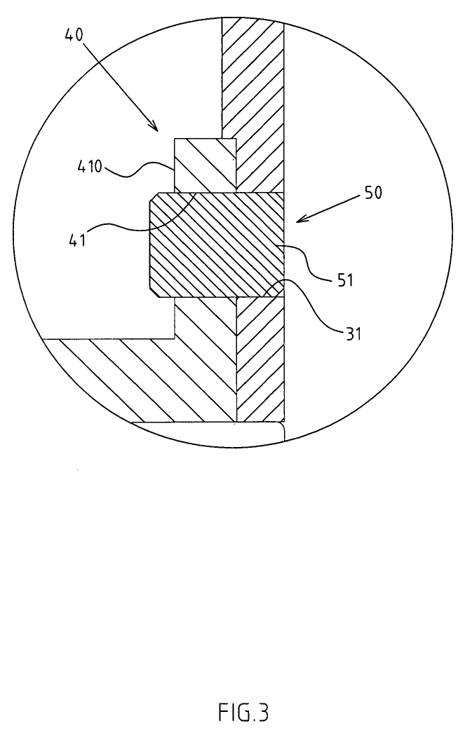

FIGS. 1-3 depict preferred embodiments of locating structure of water control valve casing of the present invention. The embodiments are provided only for explanatory objectives with respect to the patent claims.

The casing 10 of water control valve A is a hollow housing, defining a wall 11 and a internal space 12. A base 20 is assembled onto the bottom of the casing 10. The base 20 is provided with perforating hole 21. The casing 10 and base 20 are positioned securely through the locating structure. The locating structure comprises a first and second coupling portion 30, 40 opposite each other on the casing 10 and base 20. At least a locator 50 is used for combining the first and second coupling portion 30, 40.

The locating structure is assembled by the first coupling portion 30 being a punch hole 31 on the wall 11 of the casing 10. The second coupling portion 40 is a convex seat 410 with a punch hole 41 on the base 20. The locator 50 is a pin column 51, allowing to screw tightly into the punch hole 31, 410 of the wall 11 of the casing 10 and convex seat 410, as shown in FIGS. 1-3.

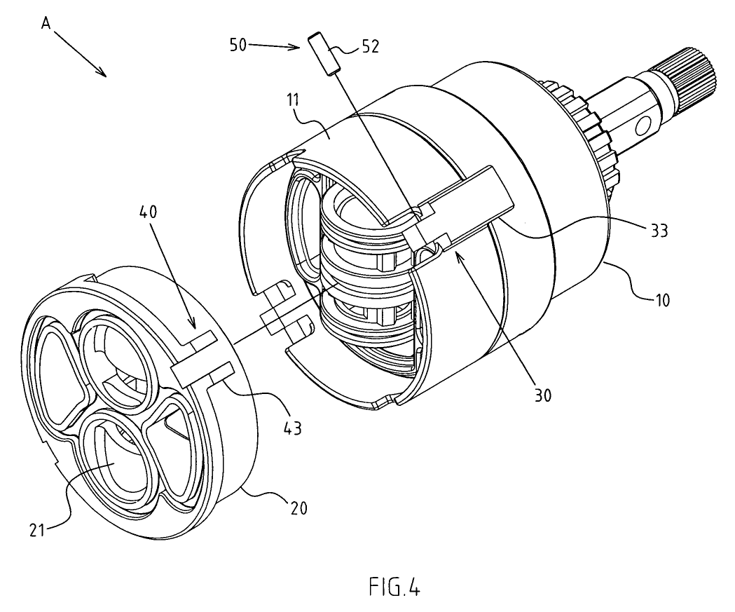

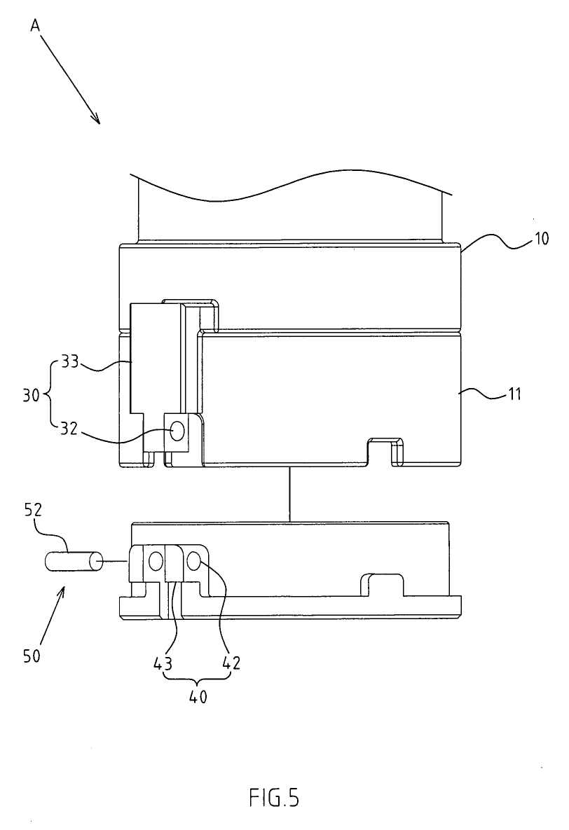

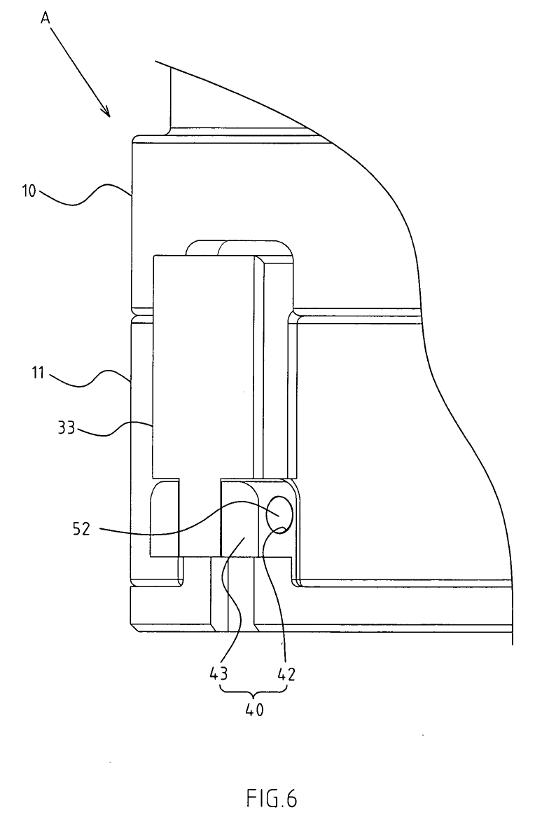

The first coupling portion 30 is a lateral bulge 33 with punch hole 32 on the wall 11 of the casing 10, and the second coupling portion 40 is a lateral convex seat 43 with punch hole 42 on the base 20. The locator 50 is a pin column 52, allowing to screw tightly into the punch hole 32, 42 of the lateral bulge 33 and lateral convex seat 43, as shown in FIGS. 4-6.

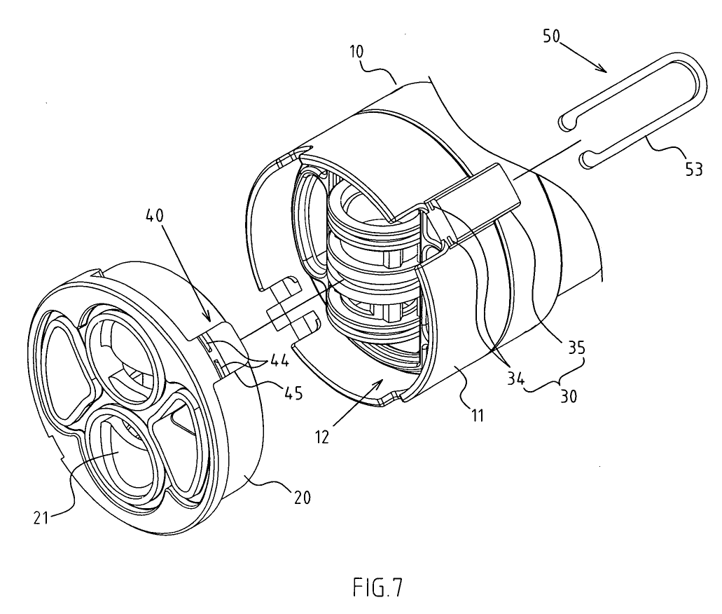

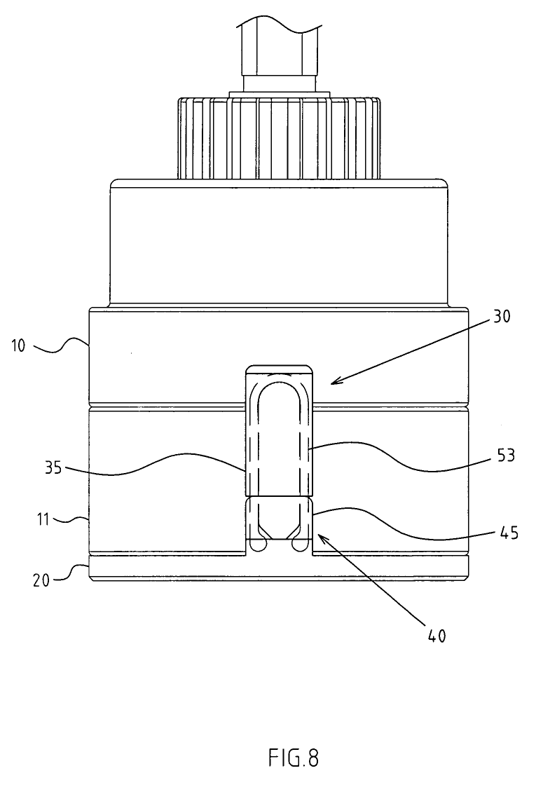

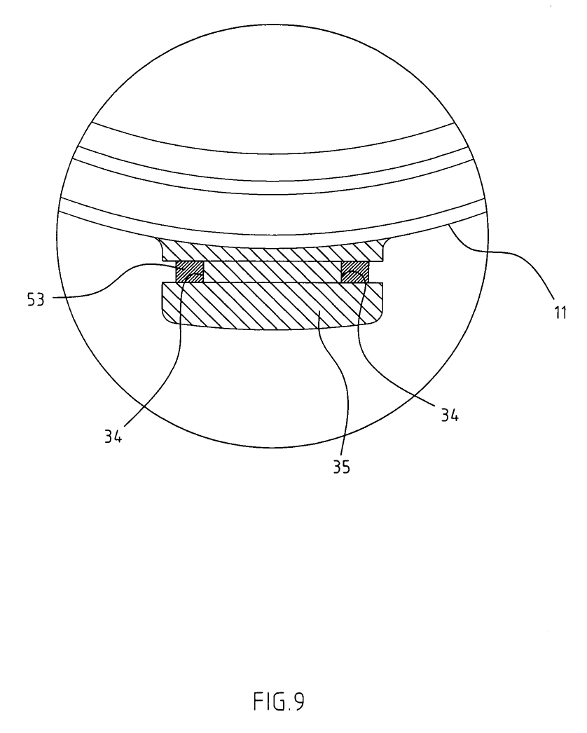

The first coupling portion 30 is a convex guide seat 35 with two guide channels 34 on the wall 11 of casing 10, and the second coupling portion 40 is a convex clamping frame 45 with two snapping channels 44 on the base 20. The locator 50 is a C-shaped fastener 53, allowing to snap into the guide channel 34 of convex guide seat 35 and snapping channel 44 of convex clamping frame 45, as shown in FIGS. 7-9.

Based on above-specified structures, the present invention is operated as follows.

Referring to FIGS. 1, 2, and 3, the convex seat 410 on the base 20 is first aligned with the punch hole 31 on the wall 11 of casing 10, so that the punch hole 41 of convex seat 410 is located co-axially with the punch hole 31, allowing tight insertion into punch hole 31, 41 of wall 11 and convex seat 410 by the pin column 51 for fixed assembly of the casing 10 and base 20.

FIGS. 4, 5, and 6 depict another preferred embodiment of the present invention. The lateral bulge 33 on the wall 11 of the casing 10 is coupled first with the lateral convex seat 43 on the base 20, so that the punch hole 32 of the lateral bulge 33 is located co-axially with the punch hole 42 of the lateral convex seat 43, allowing tight insertion into punch hole 32, 42 of lateral bulge 33 and lateral convex seat 43 by the pin column 52 for fixed assembly of the casing 10 and the base 20.

FIGS. 7, 8, and 9 depict another preferred embodiment of the present invention. The convex guide seat 35 on the wall 11 of the casing 10 is first coupled with the convex clamping frame 45 on the base 20, so that two guide channels 34C of the convex guide seat 35 are tightly mated with two snapping channels 44 of the convex clamping frame 45, allowing insertion into the guide channel 34 of convex guide seat 35 and snapping channel 44 of convex clamping frame 45 by C-shaped fastener 53 for fixed assembly of the casing 10 and base 20.

1. A locating structure of a water control valve casing, said casing being a hollow housing defining a wall and internal space and having a base assembled onto bottom thereof and a perforating hole, said casing and base being positioned securely, said locating structure comprising:
a first and second coupling portion opposite each other on said casing and base; and
at least a locator, combining said first and second coupling portion.

2. The locating structure defined in claim 1, wherein said first coupling portion is a punch hole on said wall of said casing, said second coupling portion being a convex seat with a punch hole on said base, said locator being a pin column, said pin column screwing into the punch holes of the wall of the casing and convex seat.

3. The locating structure defined in claim 1, wherein said first coupling portion is a lateral bulge with a punch hole on said wall of said casing, said second coupling portion being a lateral convex seat with a punch hole on said base, said locator is a pin column, said pin column screwing into the punch holes of a lateral bulge and lateral convex seat.

4. The locating defined in claim 1, wherein said first coupling portion is a convex guide seat with two guide channels on said wall of said casing, said second coupling portion being a convex clamping frame with two snapping channels on said base, said locator being a C-shaped fastener and snapping into a guide channel of said convex guide seat and snapping channel of convex clamping frame.
